(19) United States
(12) Patent Application Publication
(10) Pub. No.: US 2018/0138464 A1
(43) Pub. Date: May 17, 2018

(54) BATTERY CELL HOUSING AND METHOD FOR PRODUCTION OF SAME

(71) Applicant: SCHULER PRESSEN GMBH, Goeppingen (DE)

(72) Inventors: CARSTEN BRECHLING, ULM (DE); RAINER BERKEFELD, BAD HONNEF (DE)

(73) Assignee: SCHULER PRESSEN GMBH, GOEPPINGEN (DE)

(21) Appl. No.: 15/870,888

(22) Filed: Jan. 13, 2018

Related U.S. Application Data
(63) Continuation-in-part of application No. PCT/EP2016/065816, filed on Jul. 5, 2016.

(30) Foreign Application Priority Data
Jul. 16, 2015 (DE) 102015111572.7

(51) Int. Cl. H01M 2/02; H01M 2/04; H01M 10/0583; H01M 10/0587; H01M 2/36; H01M 2/12; H01M 10/42

(52) U.S. Cl. CPC H01M 2/022; H01M 2/0408; H01M 10/0583; H01M 10/0565; H01M 2/36; H01M 2/12; H01M 10/425; H01M 10/0587

(57) ABSTRACT

A battery cell housing which delimits an interior chamber for receiving a core material providing electrical energy. The battery cell housing consists of a housing shell and a housing cover. The housing shell has a floor and a housing shell wall extending coaxially to a housing axis, proceeding from the floor. The housing cover has a pot or bowl-shaped form. The housing cover is inserted into the housing shell wall at a distance from the floor after the core material has been introduced. The housing shell wall is mechanically connected to the housing cover by a folded joint, preferably a double folded joint. There is no integrally joined connection according to the invention. The folded joint is implemented radially inward toward the housing axis and is located closer to the housing axis than the outer surface of the housing shell wall, when viewed radially to the housing axis.

### CROSS-REFERENCE TO RELATED APPLICATIONS

This is a continuation-in-part application of pending international application PCT/EP2016/065816 filed Jul. 5, 2016, and claiming the priority of German application No. 102015111572.7 filed Jul. 16, 2015. The said International application PCT/EP2016/065816 and German application No. 102015111572.7 are both incorporated herein by reference in their entireties as though fully set forth.

### BACKGROUND OF THE INVENTION

The invention relates to a battery cell housing for the accommodation of a core material that provides electrical energy. Furthermore, the invention relates to a method for the production of the battery cell housing.

The battery cell housing comprises a housing shell and a housing cover connected to the housing shell. With the connection established, the housing shell and the housing cover enclose an interior chamber, in which the core material is located. The housing cover and the housing shell are connected to each other in a suitable manner. Frequently, the housing cover is connected in a substance-to-substance bonded manner to the housing shell.

Furthermore known have been battery cell housings wherein the housing cover is connected to a circumferential wall via a folded joint. Such a battery cell housing has been known from publication DE 10 2010 030 993 A1. In this case, it is disadvantageous that the fold projects beyond the outside dimensions of the circumferential wall adjoining the fold and thus enlarges the space taken up by the battery cell housing in this installation region. If several battery cell housings are arranged next to each other, the circumferential walls cannot be in contact with each other due to the fold, and/or they cannot be randomly arranged next to each other but display—depending on the size of the fold—a minimum distance from each other.

Publication DE 699 28 674 T2 suggests that a folded joint be provided between the housing cover and the housing shell in a region in which the circumferential wall is drawn inward and the interior chamber in the region of the housing opening is tapered. The folded joint implemented toward the outside is arranged in the region displaying the radially smallest dimension and thus does not project beyond the clearance zone of the battery cell housing. However, it has been found that the conical constriction must occur before the introduction of the core material in the battery cell housing. Otherwise dirt particles may enter the interior chamber and impair the electrical or electronic function of the core material. The introduction of the core material following the constriction is also disadvantageous. In a housing shell with a housing wall that tapers or constricts toward the housing opening, a cylindrically contoured core material of a solid substance will potentially no longer fill the entire interior chamber, so that the energy density of the battery cell is reduced. This known battery cell housing is thus especially suitable for at least partially liquid or gelatinous core materials.

Publication DE 601 05 076 T2 suggests a battery cell housing, wherein a positive-locking connection is established between a circumferential wall of a housing shell and a housing cover in that a connecting section of the housing shell wall is constricted inward toward the housing axis. The housing cover is axially enclosed between the constriction and an axial end section that is molded inward. The radial constriction is as disadvantageous as the constriction described hereinabove.

Considering this prior art, the object to be achieved by the present invention may be viewed to be the provision of a battery cell housing that maximizes the available interior space for the core material and, at the same time, ensures a small design and a simple production.

### SUMMARY OF THE INVENTION

This object is achieved by a battery cell housing and by a method for the production of the battery cell housing displaying the features of the claims. The invention relates to a battery cell housing 15 which delimits an interior chamber 18 for receiving a core material 19 providing electrical energy. The battery cell housing 15 consists of a housing shell 16 and a housing cover 17. The housing shell 16 has a floor 20 and a housing shell wall 21 extending coaxially to a housing axis G, proceeding from the floor. The housing cover 17 has a pot or bowl-shaped form. The housing cover is inserted into the housing shell wall 21 at a distance from the floor 20 after the core material 19 has been introduced. The housing shell wall 21 is mechanically connected to the housing cover 17 by a folded joint 31, preferably a double folded joint. There is no integrally joined connection according to the invention. The folded joint 31 is implemented radially inward toward the housing axis G and is located closer to the housing axis G than the outer surface of the housing shell wall 21, when viewed radially to the housing axis G.

The battery cell housing comprises an interior chamber for the accommodation of a core material that provides electrical energy. The core material may consist of a solid substance, a gel or a fluid. The battery cell housing according to the invention is also particularly suitable for a wound element of a solid core material that is also referred to as a “jelly roll” or a “Swiss roll”.

The battery cell housing comprises a housing shell and a housing cover connected to the housing shell by means of a folded joint. Preferably, the battery cell housing consists of only these two parts.

The housing shell has a floor and a housing shell wall adjoining the floor, said housing shell wall enclosing a housing axis. The housing shell wall has a hollow cylindrical circumferential section that adjoins the floor and extends in axial direction away from the floor. On the axial side opposite the floor, a connecting section of the housing shell wall adjoins the hollow cylindrical circumferential section. The connecting section delimits a housing opening. Prior to connecting the housing shell to the housing cover, the connecting section is also hollow cylindrical and has the same inside diameter and/or outside diameter as the circumferential section.

Before being connected to the housing cover, the circumferential section and the connecting section have a cross-section in the form of a circular cylinder. Also, other cylindrical cross-sectional forms can be used such as polygonal or arcuate cross-sections, or cross-sections that are linear and curved in different parts can be used alternatively.

In a preferred embodiment the housing shell wall comprises at least one pair of opposing parallel plane wall sections that are connected via wall sections that are curved, at least in some parts, in order to form the housing shell wall. Each wall section that is curved at least in some sections may have a constant radius of curvature in the curved regions. Each wall section that is curved in at least in some parts—viewed in cross-section—may have the form of a circular arc, for example have the contour of a semi-circle. At least each wall section that is curved in at least some parts may, alternatively, also have several regions of curvature.

The radius of curvature of each region of a wall section that is curved in at least in some parts and adjoins a plane wall section, amounts to preferably 4 times the thickness of the circumferential section of the housing shell wall. The radius of curvature of each region of a wall section that is curved in at least in some parts and adjoins a plane wall section, is preferably half as great as half the distance between opposite plane wall sections.

The housing cover has a cover part extending obliquely or, preferably, at a right angle, relative to the axial direction. Adjoining the cover part, there is an edge part. The edge part encloses the housing axis in the form of a ring. The edge part may consist of several sections and, for example, comprise a hollow cylindrical lateral section that is connected to the cover part. On the axial side opposite the cover part, the lateral section may have a flange section that extends obliquely or at a right angle relative to the axial direction, inward toward the housing axis. The outside dimension of the edge part is at most as great as the inside dimension of the connecting section, so that the housing cover can be inserted in the connecting section of the housing shell wall and can be connected to the connecting section by creating a folded joint. With the connection established, the cover part of the housing cover is arranged in such a manner that it is enclosed by the hollow cylindrical circumferential section. Between the floor of the housing shell and the cover part, the interior chamber is cylindrical and preferably has a constant interior cross-sectional area and, in accordance with the example, a constant inside diameter. The folded joint is produced between the connecting section and the edge part by folding the connecting section, as well as well as edge part, inward toward the housing axis. Preferably, the folded joint is a double folded joint.

Consequently, the folded joint—viewed from the circumferential section—is located farther inside relative to the housing axis, above the cover part of the housing cover. Before implementing the folded joint, the maximum possible opening cross-section of the housing opening is available. Therefore, it is also possible to introduce solid core material into the interior chamber, said core material maximally filling the interior chamber at a right angle relative to the axial direction or the housing axis and thus making possible a high energy density of the battery cell. Furthermore, the folded joint does not project beyond the cylindrical clearance zone of the battery cell housing, so that several battery cell housings can be arranged very tightly next to each other and, if necessary, in contact with each other, in the installation space of a battery.

The housing shell and the housing cover are electrically isolated at least relative to the interior chamber. To accomplish this, they may be provided with a coating. The housing shell and the housing cover may also be coated toward the outside or be electrically isolated. For example, the housing shell and the housing cover can be made of a sheet metal material by shaping, said material having, on one or on both sheet sides, an electrically isolating coating. This isolation may also be accomplished by applying a coating after the housing shell or the housing cover have been produced.

It is preferred if the folded joint is arranged completely within a region delimited by the curved surface of a hollow cylinder. The curved surface of the hollow cylinder is a surface into which extends the outside surface of the circumferential section and which encloses the entire battery cell housing in axial direction.

Preferably, the housing shell, as well as the housing cover, is located completely within the region delimited by the curved surface of the hollow cylinder.

The battery cell housing and the housing shell, respectively, and the housing cover are preferably made of a metal or a metal alloy that may contain steel or aluminum, for example. The housing shell may be produced from a blank by means of a deforming process, for example by impact extrusion or ironing.

The battery cell housing can be used for any type of electrical energy storage such as, for example, a disposable battery, a rechargeable battery, a capacitor, etc.

In one embodiment, the inside dimensions and/or the outside dimension of the circumferential section of the shell housing wall is constant. Viewed in cross-section, the inside contour and the outside contour of the circumferential preferably have the form of a circle.

It is also possible to provide at least one support projection for the housing cover at a location of the circumferential section of the shell housing wall in order to specify the position of housing cover within the housing shell wall, before the folded joint is made. The at least one support projection may be produced, for example, by changing the thickness of the housing shell wall. The at least one support projection can also be produced by local shaping of the circumferential section. The at least one support projection may be closed in the form of a ring in circumferential direction around the housing axis, or several support projections—at least three—may be provided at a distance from each other in circumferential direction.

The housing cover and/or the housing shell may be made in one piece or integrally, without seams and joints.

It is advantageous if the edge part of the housing cover has a first cover fold section and a second cover fold section that—with the connection with the connecting section established—are arranged coaxially relative to each other.

The connecting section of the housing shell wall may have a first shell fold section and a second shell fold section that—with the connection with the housing cover established—are arranged coaxially relative to each other.

In doing so, it is advantageous if the first shell fold section is arranged between the first cover fold section and the second cover fold section and preferably abuts directly against the two cover fold sections. Preferably, the second cover fold section may be arranged between the first shell fold section and the circumferential section of the housing shell wall and preferably abuts directly against the shell fold section and the circumferential section.

Furthermore, the first cover fold section may be located between the first shell fold section and the second shell fold section and preferably abuts directly against the two shell fold sections.

Due to the one or more embodiments of the folded joint, it is possible to achieve a tight connection between the housing cover and the housing shell, said connection being produced in a simple manner.

The exemplary embodiment provides that the thicknesses of the starting sheet metal, of which the housing shell and the housing cover are made, are the same.

In order to create the connection of the housing shell described hereinabove and the housing cover described hereinabove, it is possible to proceed as follows:

In unshaped condition, the circumferential section, as well as the connecting section, each have the form of a hollow cylinder—preferably with the same outside dimensions. The inside dimension of the connecting section is at least as great as the inside dimension of the circumferential section. Consequently, the maximum cross-section is available for the insertion of the core material on the housing opening. Upon introducing the core material into the housing shell, the interior chamber is closed in that the housing shell is connected to the housing cover by producing the folded joint.

In order to produce the folded joint, the housing cover is inserted along the housing axis into the housing shell, so that the housing shell wall encloses the housing cover in circumferential direction. In this position, the connecting section of the housing shell wall is located, at least partially in axial direction, above the housing shell cover. The folded joint is produced with the aid of a folding device using one or more tools. The connecting section and at least one flange section of the edge part are folded over or flanged inward toward the housing axis, as a result of which an interlocking connection is formed. The connecting section and the edge section may be pressed or squeezed together at a right angle relative to the housing axis in order to improve the folded joint.

### BRIEF DESCRIPTION OF THE DRAWINGS

Advantageous embodiments of the invention result from the claims, the description and the drawings. Hereinafter, preferred embodiments of the invention are explained in detail with reference to the appended drawings. They show in:

FIG. 1 a schematic perspective representation of an exemplary embodiment of a battery cell housing,

FIG. 2 a representation, partially in section, of the folded joint between a housing cover and a housing shell in the case of the battery cell housing according to FIG. 1—in region II,

FIG. 3 an exploded view of the battery cell housing of FIG. 1,

FIG. 4 a partial view of a longitudinal section through the exemplary embodiment of the battery cell housing of FIGS. 1 to 3, prior to the implementation of the folded joint,

FIG. 5a an exemplary embodiment of a battery cell housing that has been modified compared with FIG. 4, with a shell housing wall having a thickness that changes at one point,

FIG. 5b an exemplary embodiment of a battery cell housing that has been modified compared with FIG. 5a, wherein a separate installation part is provided as the support for the housing cover,

FIGS. 6 to 8 a schematic exemplary illustration of different stages of the production of a folded joint with the aid of a folding device,

FIG. 9 a longitudinal section through an exemplary embodiment of the battery cell housing in the region of the housing cover, with the folded joint established,

FIGS. 10 and 11 perspective partial representations of respectively one exemplary embodiment of the floor of the battery cell housing,

FIG. 12 a schematic plan view onto the housing cover parallel to the housing axes, of several of the battery cell housings, and

FIGS. 13 to 15 schematic illustrations of cross-sections through a housing shell.

### DETAILED DESCRIPTION OF THE INVENTION

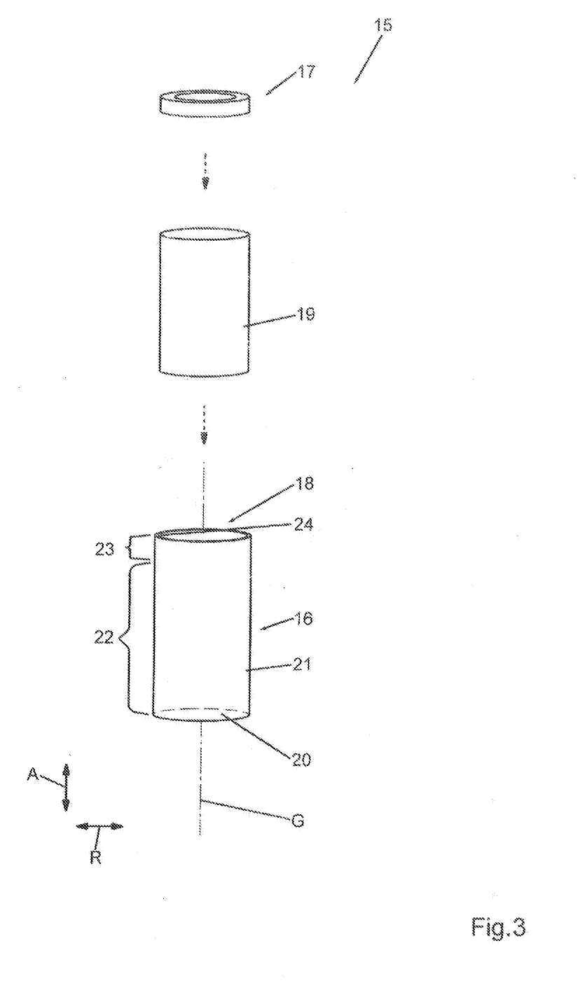

FIGS. 1 and 3 show an exemplary embodiment of a cylindrical battery cell housing 15 that, in accordance with the example, has the form of a circular cylinder. The battery cell housing 15 comprises a housing shell 16 and a housing cover 17. In the exemplary embodiment, the battery cell housing 15 consists only of these two parts 16, 17.

The battery cell housing 15 delimits an interior chamber 18 that is disposed and provided for the accommodation of core material and, preferably, a solid core material 19. The solid core material 19 may be, for example a wound body that is also referred to as a “jelly roll” or a “Swiss roll”. As illustrated by FIG. 3, the solid core material 19 has a cylindrical contour and, in accordance with the example, the contour of a circular cylinder. The inside diameter of the interior chamber 18 corresponds to the outside diameter of the solid core material 19, apart from a necessary clearance.

The housing shell 16 has a floor 20, as well as a housing shell wall 21 surrounding a housing axis G. The housing axis G extends in an axial direction A. The direction radial to the housing axis G is referred to as the radial direction R.

The housing shell wall 21 adjoins the floor 20 and completely surrounds the floor 20 in circumferential direction around the housing axis G. The housing shell wall 21 has—adjoining the floor 20—a circumferential section having the contour of a hollow cylinder. The inside diameter of the circumferential section 22 specifies the inside diameter of the interior chamber 18.

On the axial side, opposite the floor 20, the circumferential section 22 transitions into a connecting section 23. The connecting section 23—in not deformed initial condition of the housing shell 16 (FIG. 3)—also has the form of a hollow cylinder and, in one exemplary embodiment, can have the same inside diameter and the same outside diameter as the circumferential section 22. The connecting section 23 delimits a housing opening 24 through which the core material 19 can be introduced into the housing shell 16. In the exemplary embodiment, the cross-section of the housing opening 24 is circular and, in not deformed condition of the housing shell 16, corresponds to the inside diameter of the connecting section 23 and, in accordance with the example, also to the inside diameter of the circumferential section 22, as well as of the interior chamber 18. Consequently, the complete inner chamber cross-section is available for the introduction of the core material 19.

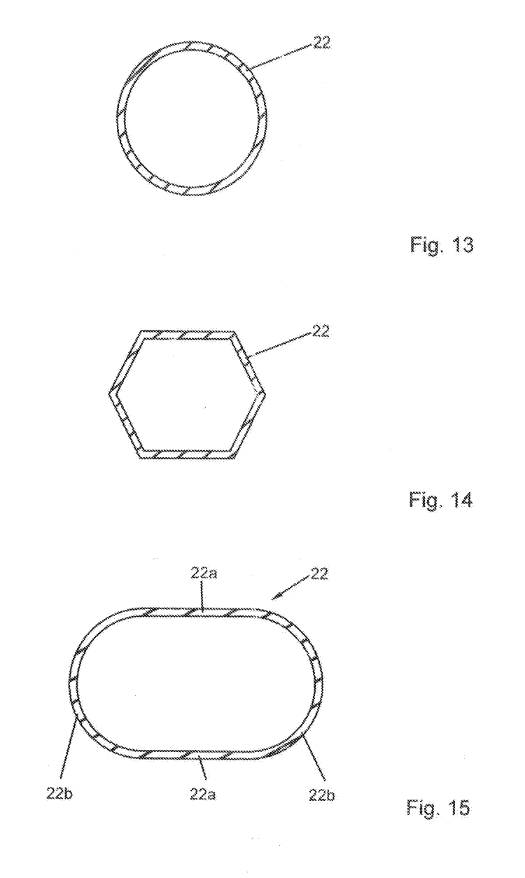

FIGS. 13 to 15 show, as examples, different cylindrical forms of the housing shell 16, in cross-section through the circumferential section 22. As already explained, the housing shell may have the cross-section of a circular cylinder (FIG. 13), Alternatively thereto, it is also possible to design a housing shell 16 with a polygonal cross-section. A hexagon is shown only as an example in FIG. 14. The number of corners may be varied. The polygonal cross-section may be regular or irregular.

A cylindrical form of the housing shell with an oval or “race-track-shaped” cross-section is schematically shown by FIG. 15. The housing shell wall 21 and the circumferential section 22, respectively, have oppositely located parallel plane wall sections 22a. The two plane wall sections 22a are at a distance from each other. They are connected to each other by several—two according to the example—curved wall sections 22b. In the exemplary embodiment, each curved wall section 22b has a constant radius of curvature. Viewed in cross-section, each curved wall section 22b has the form of a semi-circle. Alternatively thereto, it is also possible that each plane wall section 22a is adjoined on both sides by a curved wall section 22b each, the latter having the same radius of curvature and being connected to each other via a transition wall section. For example, the transition wall section may be plane or have another configuration.

The radius of curvature of the at least partially curved wall sections 22b corresponds at most to half the distance between the two plane wall sections 22a and may also be smaller if the curved regions are connected to each other by another region. In the exemplary embodiment, the radius of curvature is at least four times as large as the wall thickness of the circumferential section 22.

Preferably, the connecting section 23—in its not deformed condition before the connection with the housing cover 17 is produced—has the same cross-section as that of the circumferential section 22 of the housing shell wall 21, as illustrated by FIGS. 13 to 15.

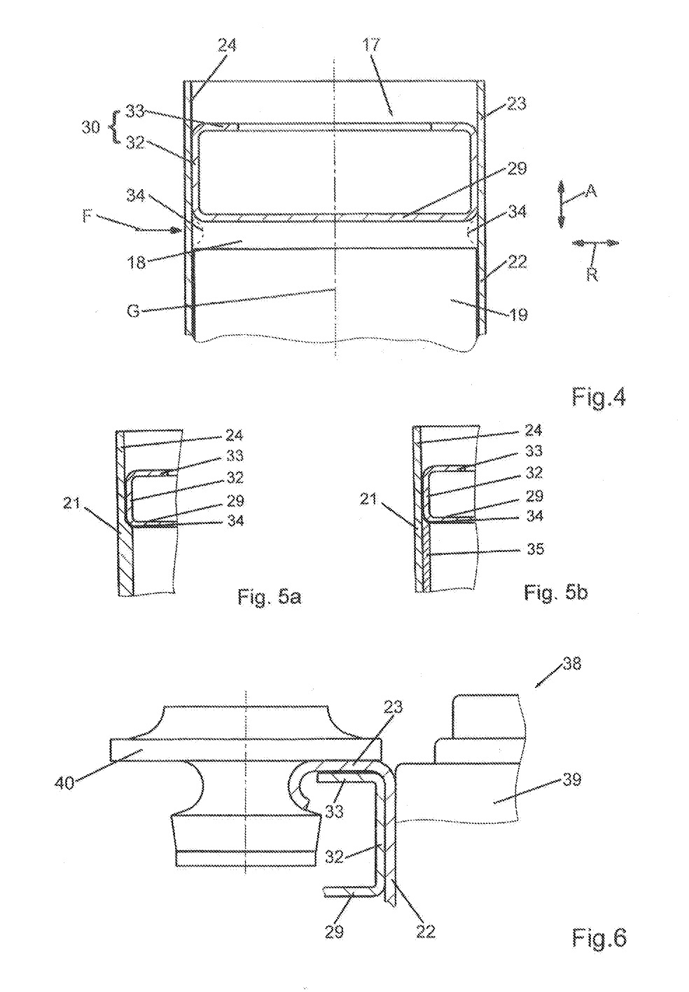

With reference to FIGS. 3 and 4, the housing cover 17 has a cover part 29 that extends in radial direction R in the exemplary embodiment. The cover part 29 could also extend, at least in some parts, in a manner oblique to the housing axis G.

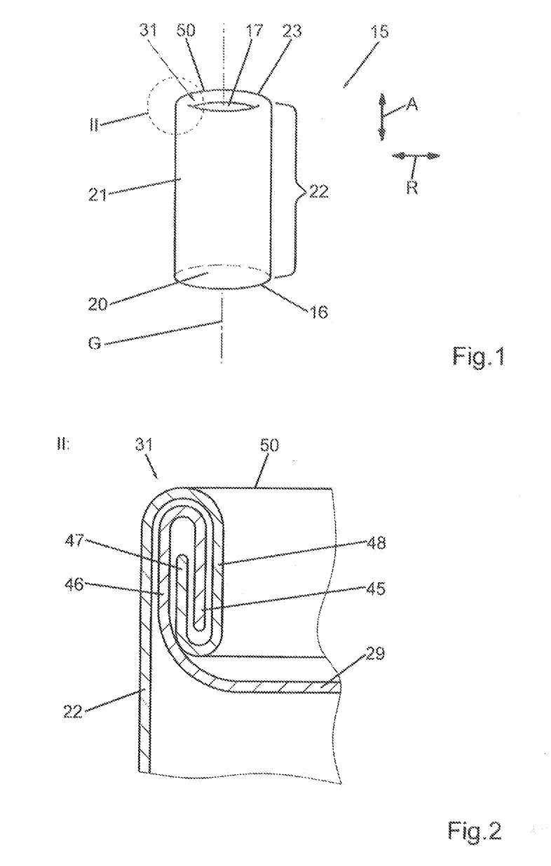

An edge part 30 adjoins the cover part 29. The edge part 30 is disposed to form a folded joint 31 with the connecting section 23 of the housing shell wall 21 (FIGS. 2 and 9). FIG. 4 shows the housing cover 17 in its non-deformed initial condition. In its non-deformed initial condition, the housing cover 17 has the form resembling that of a pot or bowl. In this initial condition, the edge part 30 is formed by a lateral section 32 and a flange section 33. The lateral section 32 extends coaxially with respect to the housing axis G and forms a hollow cylindrical part of the housing cover 17, as long as said cover is still not deformed. The flange section 33 has the form of a ring that surrounds the housing axis G. In the exemplary embodiment, the flange section 33 extends in a radial plane. It could also have a conical form and be oriented inclined with respect to the housing axis G. Preferably, when the folded joint 31 is being implemented, the flange section 33 is reshaped together with the connecting section 23. The lateral section 32 can remain at least substantially non-deformed.

For the production of the battery cell, the core material 19 is introduced into the housing shell 16 and arranged there in the interior chamber 18. Subsequently, the housing cover 17 is arranged above the core material 19 inside the housing shell wall 21. Initially, the housing cover 17 is in its starting condition described hereinabove. In order to arrange the housing cover 17 in a defined position, there may be at least one support projection 34 that extends away from the housing shell wall 21 and, in particular, from the circumferential section 22, in radial direction R toward the housing axis G. For example, it is sufficient to provide—in circumferential direction distributed around the housing axis G—several and, as in the example, three support projections 34. For example, they may also be produced following the introduction of the core material by pressing in the housing shell wall 21 due to a deforming force F. Inasmuch as the support projections 34 are not associated with the folded joint 32, they may be very small in radial direction R and, for example, have a radial dimension that corresponds to at most 1.0 times or 1.5 times, or 2.0 times the thickness of the circumferential section 22 at this point.

For example, the support projections 34—viewed from the inside—may be concave and—viewed from the outside—convex in the circumferential section 22 of the housing shell wall 21. FIG. 4 shows, schematically, bump-shaped support projections 34 in dashed lines.

Alternatively thereto, it is also possible to increase the thickness of the housing shell wall 21 at the point where the cover part 29 of the housing cover 17 is to be located and thus form an annular support projection. In doing so, the support projection may extend in a radial plane R or be obliquely inclined relative to the housing axis G. FIG. 5a shows, schematically, a ring-shaped, closed support projection 34 that is formed by a thickness change of the housing shell wall 21. FIG. 5b shows an exemplary embodiment, wherein the support projection 34 is formed by an insert part 35 that, preferably is made of plastic material. For example, the insert part 35 may have the form of a hollow cylinder. The outside diameter of the insert part 35 may essentially correspond to the inside diameter of the circumferential section 22 of the housing shell wall 21. The upper edge of the insert part 35 may extend in a plane at a right angle relative to the housing axis G or be inclined relative thereto, so that said insert part is seated on the curved surface of a cone. The insert part 35 may be inserted before the introduction of the core material 19 into the housing shell 16 of the battery cell housing 15.

As is shown by FIGS. 4 and 5a and 5b, the housing cover 17 has a maximum outside radius that—apart from a required clearance—corresponds to the inside radius of the housing wall section 21 in the region of the housing opening 24, at least up to the point where the cover part 29 of the housing shell 16 is to be arranged, i.e., for example, up to the at least one support projection 34.

After arranging the housing cover 17 in the housing shell 16, the folded joint 31 is implemented between the connecting section 23 of the housing shell wall 21 and the edge part 30 and, in particular, the flange section 33. The process is illustrated in a highly simplified manner by FIGS. 6 to 8.

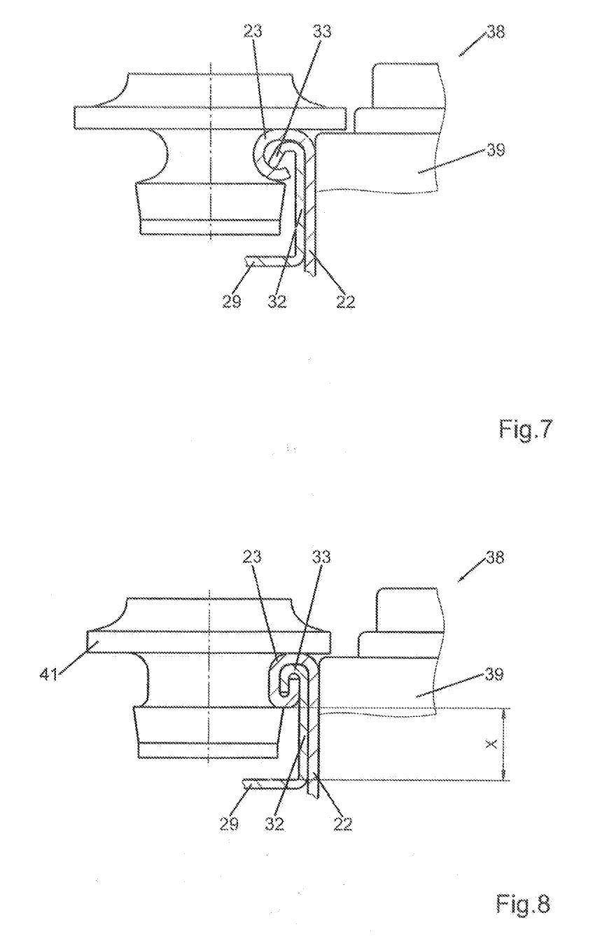

In order to produce the folded joint 31, a folding device 38 comprising several tools is used. FIGS. 6 and 7 show both a first tool 39 and a second tool 40. The two tools 39, 40 come into contact from opposite radial sides. The first tool 39 is cylindrical in some sections and presses against the outside of the housing shell wall 21 in the region in which the housing cover 17 is located. The second tool 40 extends into the pot-shaped housing cover 17. The reforming process to produce the folded joint 31 is accomplished with the tools of the folding device 38.

During a first, not illustrated, step the housing shell wall 21 is angled inward in the connecting section 23, so that said wall abuts against the flange section 33 or extends over the flange section 33.

The second tool 40 has a concave recess, for example a concave annular groove, into which extend the ends of the connecting section 23 and the flange section 33 associated radially with the housing axis G. In doing so, the connecting section 23 is moved or folded around the radially inner edge of the flange section 33, as it were, by means of the second tool 40. With the continued movement of the tools 39, 40, the flange section 33 is bent over at a bending location, so that its free edge initially faces in an oblique direction toward the cover part 29 (FIG. 7).

As an alternative to the above-described rolling of the connecting section 23 and the housing cover 17 and the flange section 33, respectively, it is possible to implement the interlocking intermediate step shown by FIG. 7 also by means of an upsetting process with a movement in the direction of the housing axis G.

For further shaping, the second tool 40—in accordance with the example or if the second tool 40 does not have the desired form—is replaced by a third tool 41 having a concave recess or annular groove in the form that the folded joint 31 is ultimately to have, and that, for example, is slightly greater in axial direction than the concave recess of the second tool 40. The first tool 39 and the third tool 41 are pressed against each other in radial direction, so that the edge part 30 and, in particular, the flange section 33 are tightly pressed together with the connecting section 23, and the folded joint 31 is produced.

Independent of the various methods of producing the folded joint 31, the housing part 17 and the housing shell 15 are pressed together in a pressure-sealed manner.

The completed folded joint 31, for example, is schematically illustrated by FIGS. 2 and 9. In accordance with the example, the connection between the housing cover 17 and the housing shell 16 is effected only by means of the folded joint 31. A substance-to-substance connection is not provided.

Due to the reforming process during the implementation of the folded joint 31, a first cover fold section 45 has formed on the edge part 30 and a second cover fold section 46 has formed, in which case the second cover fold section 46 coaxially encloses the first cover fold section 45. The first cover fold section 45 adjoins the free edge of the reshaped flange section 33. The second cover fold section 45 is represented by a region of the lateral section 32 that adjoins the flange section 33.

A first shell fold section 47, as well as a second shell fold section 48, have been formed on the connecting section 23. The first shell fold section 47 coaxially encloses the second shell fold section 48. The first shell fold section 47 is arranged between the two cover fold sections 45, 46 and is directly in contact therewith or is clamped between the two cover fold sections 45, 46. Analogously, the first cover fold section 45 is arranged between the two shell fold sections 47, 48 and is directly in contact with these or is clamped between these. The fold sections 45, 46, 47, 48 extend coaxially relative to the housing axis G in axial direction A. The second cover fold section 46 is coaxially surrounded by the circumferential section 22 of the housing shell wall 21 and is in direct contact therewith.

A transition section is provided between the two cover fold sections 45, 46, said transition section being curved at least in some parts. Analogously thereto, there is a transition section between the two shell fold sections 47, 48, said transition section being curved in at least some parts. Furthermore, the second shell fold section 48 is connected to the circumferential section 22 of the housing shell wall via a transition section that is curved at least in some parts and on which the upper edge 50 of the battery cell housing 15 is formed.

The upper edge 50 is arranged in axial direction A at a distance from the cover part 29 of the housing cover 17 (FIGS. 2 and 9). This distance is a function of the free space x in axial direction A between the cover part 29 and the transition section from the first shell fold section 47 to the second shell fold section 47 that is required by the tools 40, 41 during the production of the folded joint (FIG. 8).

In accordance with the example, both the housing cover 17 and the housing shell 16 are produced without seams and joints. The housing cover 17 and the housing shell 16 may consist of metal or a metal alloy that contains steel or aluminum. The housing cover 17, as well the housing shell 16 are electrically isolated with respect to the interior chamber 18. To accomplish this, an electrically isolating coating may be provided. This coating may already be present on the starting sheet metal from which the housing cover 17 and the housing shell 16, respectively, are produced. The battery cell housing 15 may also be completely covered by an electrically isolating coating.

The folded joint 31 is located completely within the axial clearance zone of the battery cell housing 15. In other words: a hollow cylindrical curved surface M extending coaxially with respect to the housing axis G is defined, said curved surface completely holding the battery cell housing 15. The curved surface of the hollow cylinder M defines a cylindrical region B around the housing axis G, from which region the folded joint 31 does not project. In accordance with the example, the entire battery cell housing 15 is located within this region B. In doing so, the curved surface of the hollow cylinder M has a radius in radial direction R that corresponds to the outside radius of the circumferential section 22 of the housing shell wall 21. The curved surface of the hollow cylinder M and the resultant, defined region B are illustrated schematically by FIG. 9.

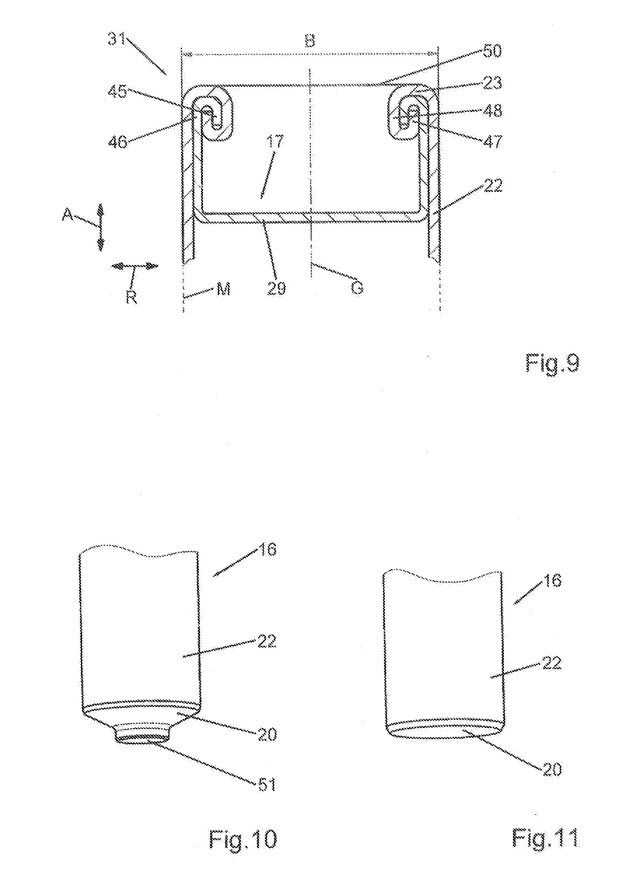

FIGS. 10 and 11 show different embodiments of the floor 20 of the housing shell 16. As in the exemplary embodiments according to FIGS. 1 and 3, the floor 20 may have the configuration of a plate or disk and extend essentially in a radial plane (FIG. 11.). Alternatively thereto, it is also possible for the floor 20 to be inclined at least in some parts or extend at a right angle relative to the radial direction R. For the formation of a battery pole, it may also have an essentially cylindrical recess—viewed from the interior chamber 18. Looking from the outside onto the battery cell housing 15, this results in an elevation 51, which is shown, for example, by FIG. 10.

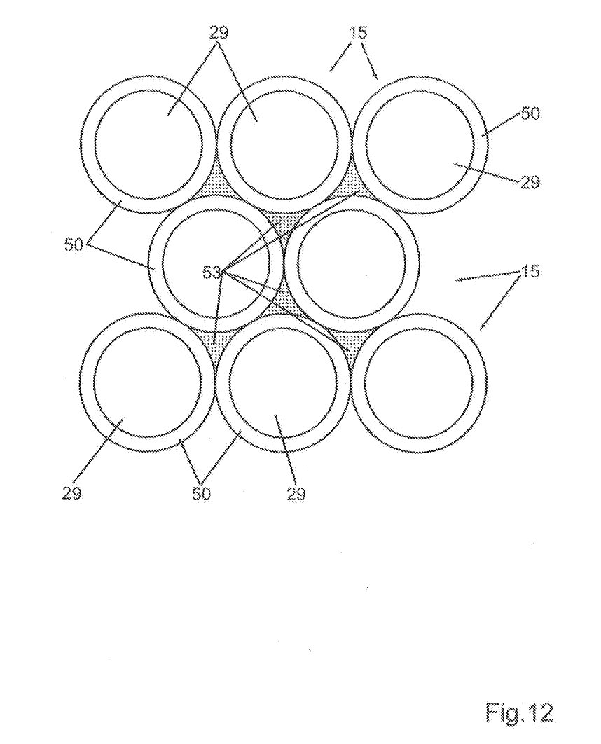

FIG. 12 shows, greatly schematized, the arrangement of several battery cell housings 15. FIG. 12 shows the battery cell housing 15—looking in axial direction A from the top onto the housing cover 17 and the cover part 29 of the housing cover 17, respectively. The upper edge 50 formed by the folded joint 31 can also be seen. The battery cell housings 15 can be connected—depending on the embodiment of the battery—electrically in series and/or in parallel. This is a function of the desired battery voltage and the desired battery power, respectively. As illustrated by FIG. 12, the battery cell housings 15 can be arranged very tightly next to each other. As a result of the fact that the folded joint 31 does not project beyond the curved surface of the hollow cylinder M, the battery cell housings 15 have a cylindrical contour and can be arranged tightly next to each other, requiring minimal space.

The adjacent battery cell housings 15 may abut against each other. In modification of the illustration of FIG. 12, they may also be arranged at a defined distance from each other. The intermediate spaces between the battery cell housings 15 can be filled with a filling material 53. The filling material may be a material that is a good heat conductor, For example, a mixture of resin with particles that are good heat conductors or a powder that is a good heat conductor may be used. The particles or the powder that is admixed to the resin may contain boron nitrite and/or copper and/or other metals and/or hydrocarbon. Instead of the particles or powder, it is also possible to use other bodies such as, for example, rods, of the mentioned materials between the battery cell housings 15. The filling material 53 may also be used for the production of a heat sink and, for example, contain a phase-changing material (PCM) such as, for example, sodium acetate or the like.

The invention relates to a battery cell housing 15 which delimits an interior chamber 18 for receiving a core material 19 providing electrical energy. The battery cell housing 15 consists of a housing shell 16 and a housing cover 17. The housing shell 16 has a floor 20 and a housing shell wall 21 extending coaxially to a housing axis G, proceeding from the floor. The housing cover 17 has a pot or bowl-shaped form. The housing cover is inserted into the housing shell wall 21 at a distance from the floor 20 after the core material 19 has been introduced. The housing shell wall 21 is mechanically connected to the housing cover 17 by a folded joint 31, preferably a double folded joint. There is no integrally joined connection according to the invention. The folded joint 31 is implemented radially inward toward the housing axis G and is located closer to the housing axis G than the outer surface of the housing shell wall 21, when viewed radially to the housing axis G.

### LIST OF REFERENCE SIGNS

15 Battery cell housing
16 Housing shell
17 Housing cover
18 Interior chamber
19 Core material
20 Floor
21 Housing shell wall
22 Circumferential section
23 Connecting section
24 Housing opening
29 Cover part
30 Edge part
31 Folded joint
32 Lateral section
33 Flange section
34 Support projection
35 Insert part
38 Folding device
39 First tool
40 Second tool
41 Third tool
45 First cover fold section
46 Second cover fold section
47 First shell fold section
48 Second shell fold section
50 Upper edge
51 Elevation
53 Filling material
A Axial direction
B Region
F Forming force
G Housing axis
M Curved surface of hollow cylinder
R Radial direction
x Free space

What is claimed is:

1. A battery cell housing (15) comprising:
an interior chamber (18) for the accommodation of a core material (19) that provides electrical energy,
a housing shell (16) that has a floor (20) and a housing shell wall (21) enclosing a housing axis (G), said housing shell wall having a hollow cylindrical circumferential section (22) extending in axial direction (A) away from the floor (20) and having a connecting section (23) adjoining the circumferential section (22) on the axial side opposite the floor (20), said connecting section (23) delimiting a housing opening (24),
a housing cover (17) that has a cover part (29) extending obliquely or at a right angle relative to the axial direction (A) and has an edge part (30) adjoining the cover part (29) and surrounding the housing axis (G), wherein the outside dimension of the edge part (30) corresponds at most to the inside dimension of the connecting section (23) of the housing shell wall (21),
wherein the cover part (29) of the housing cover (17) is surrounded by the circumferential section (22) of the housing shell wall (21), and the edge part (30) is connected to the connecting section (23) of the housing shell wall (21) by a folded joint (31) that is flanged inward toward the housing axis (G), so that the housing opening (24) is closed.

2. The battery cell housing of claim 1,
characterized in that the folded joint (31) is arranged completely inside a region delimited by a curved surface of a hollow cylinder (M), wherein the outside surface of the circumferential section (22) extends along the curved surface of the hollow cylinder (M).

3. The battery cell housing of claim 2,
characterized in that the housing shell (16), as well as the housing cover (17), are arranged completely within a region delimited by the curved surface of the hollow cylinder (M), wherein the outside surface of the circumferential section (22) extends along the curved surface of the hollow cylinder (M).

4. The battery cell housing of claim 1,
characterized in that the inside dimension and/or the outside dimension of the circumferential section (22) of the housing shell wall (21) is constant.

5. The battery cell housing of the claim 1,
characterized in that at least one support projection (34) for the housing cover (17) is provided on the inside surface of the housing shell wall (21) or the circumferential section (22), facing the interior chamber (18).

6. The battery cell housing of claim 1,
characterized in that the folded joint (31) is configured as a double folded joint.

7. The battery cell housing of claim 1,
characterized in that the housing cover (17) and/or the housing shell (16) is made in one piece without seams or joints respectively.

8. The battery cell housing of claim 1,
characterized in that the edge part (30) of the housing cover (17) has a first cover fold section (45) and a second cover fold section (46) which are arranged coaxially relative to each other.

9. The battery cell housing of claim 1,
characterized in that the connecting section (23) of the housing shell wall (21) has a first shell fold section (47) and a second shell fold section (48) which are arranged coaxially relative to each other.

10. The battery cell housing of claim 9,
characterized in that the edge part (30) of the housing cover (17) has a first cover fold section (45) and a second cover fold section (46) which are arranged coaxially relative to each other and that the first shell fold section (47) is arranged between the first cover fold section (45) and the second cover fold section (46).

11. The battery cell housing of claim 9,
characterized in that the edge part (30) of the housing cover (17) has a first cover fold section (45) and a second cover fold section (46) which are arranged coaxially relative to each other and that the second cover fold section (46) is arranged between the first shell fold section (47) and the circumferential section (22) of the housing shell wall (21).

12. The battery cell housing of claim 9,
characterized in that the edge part (30) of the housing cover (17) has a first cover fold section (45) and a second cover fold section (46) which are arranged coaxially relative to each other and that the first cover fold section (45) is arranged between the first shell fold section (47) and the second shell fold section (48).

13. A method for the production of a battery cell housing (15) having an interior chamber (18) for the accommodation of a core material (19) providing electrical energy, said method comprising the following steps:
providing a housing shell (16) that has a floor (20) and a housing shell wall (21) surrounding a housing axis (G), said housing shell wall having a hollow cylindrical circumferential section (22) extending in axial direction (A) away from the floor (20) and having a connecting section (23) adjoining the circumferential section (22) on the axial side opposite the floor (20), said connecting section (23) delimiting a housing opening (24),
providing a housing cover (16) that has a cover part (29) extending obliquely or at a right angle relative to the axial direction (A) and has an edge part (30) adjoining the cover part (29) and surrounding the housing axis (G), wherein the outside dimension of the edge part (30) corresponds at most to the inside dimension of the connecting section (23) of the housing shell wall (21),
inserting the housing cover (17) into the housing shell wall (21), so that the connecting section (23) surrounds the edge part (30),
implementing a folded joint between the connecting section (23) and the edge part (30), wherein the connecting section (23) and the edge part (30) are flanged inward toward the housing axis (G).
